(19) United States
(12) Patent Application Publication
(10) Pub. No.: US 2002/0117610 A1
(43) Pub. Date: Aug. 29, 2002

(54) Optical path structure of double-sided document scanner

(76) Inventor: Pen-Jung Lee, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/793,620

(22) Filed: Feb. 27, 2001

(51) Int. Cl. H01J 3/14

(52) U.S. Cl. 250/234

(57) ABSTRACT

The present invention provides an optical path structure of a double-sided document scanner, which comprises a first light source, a second light source, a first reflecting mirror set, a second reflecting mirror set, a lens, and a photo-sensor. The first and second light sources have a document conveyance path formed between them. The first reflecting mirror set reflects light reflected from a front face of a document toward a proper direction. The second reflecting mirror reflects light reflected from a back face of the document toward a proper direction. Lights generated by the first and second light sources can be respectively projected onto the front and back faces of the document. Lights reflected from the front and back faces of the document are respectively reflected by the first and second reflecting mirror sets and then enter the lens to be focused onto the photo-sensor.

### FIELD OF THE INVENTION

The present invention relates to an optical path structure of a double-sided document scanner and, more particularly, to an optical path structure, which is a simple structure using a single lens and a single photo-sensor and capable of scanning a double-sided document in a single pass.

### BACKGROUND OF THE INVENTION

Scanners have gradually become basic equipments of present computer systems. Documents or pictures can be feed in a scanner to be scanned and then read into a computer. The principle of a scanner is simple. The scanner projects light onto a part of a document (manuscript) and then collects reflected light to obtain an image of this part of the document. Additionally, the scanned image can be read into an image processing software for further modification. If the scanned document is a printing, an optical character recognition (OCR) software can be exploited to transform the scanned image into a file stored in a computer.

FIG. 1 shows a prior art scanner, which uses a light source 10a disposed in a main body (not shown) of the scanner to scan a document (manuscript) 11a. After the light source 10a projects light onto the document 11a, the reflected light enters a lens 13a via a mirror 12a to be focused onto a photo-sensor (e.g., charge-coupled device, CCD) 14a, which then transforms the optical signals into acceptable analog or digital signals.

However, the above prior art scanner can only perform single-sided scanning for the document 11a. If both sides of the document 11a are to be scanned, two passes of scanning must be performed, resulting in inconvenient use. If light sources, mirrors, lens, and photo-sensors are separated into two sets arranged up and down, the scanner can perform double-sided scanning in a single pass. But arrangement of the two sets of lenses and photo-sensors inevitably leads up to complexity of the whole structure so as to greatly increase the cost, hence deteriorating the competitive capacity in market.

Accordingly, the above prior art scanner has inconvenience and drawbacks in practical use. The present invention aims to resolve the above problems in the prior art.

### Summary of the Invention

The primary object of the present invention is to provide an optical path structure of a double-sided document scanner, which can scan a double-sided document in a single pass to facilitate the operation of scanning for a user. Because only a single set of a lens and a photo-sensor needs to be provided in the present invention, a simple structure is obtained, thereby greatly reducing the cost and effectively enhancing the competitive capacity in market.

To achieve the above object, the present invention provides an optical path structure of a double-sided document scanner, which comprises a first light source, a second light source, a first reflecting mirror set, a second reflecting mirror set, a lens, and a photo-sensor. The first light source and the second light source are arranged up and down with a document conveyance path formed between them. The first reflecting mirror set comprises a plurality of mirrors to reflect light reflected from a front face of a document toward a proper direction. The second reflecting mirror set also comprises a plurality of mirrors to reflect light reflected from a back face of the document toward a proper direction. The lens can focus lights reflected by the first and second reflecting mirror sets. Lights generated by the first and second light sources can be respectively projected onto the front face and the back face of the document. Lights reflected from the front face and the back face of the document are respectively reflected by the first and second reflecting mirror sets and then enter the lens to be focused onto the photo-sensor.

The various objects and advantages of the present invention will be more readily understood from the following detailed description when read in conjunction with the appended drawing, in which:

### BRIEF DESCRIPTION OF THE DRAWINGS

FIG. 1 is a side view of a prior art scanner;

FIG. 2 is a perspective view of the present invention;

FIG. 3 is a side view of the present invention;

FIG. 4 is a top view of a first light source, a first reflecting mirror set, a lens, and a photo-sensor of the present invention;

FIG. 5 is a top view of a second light source, a second reflecting mirror set, a lens, and a photo-sensor of the present invention; and

FIG. 6 is diagram showing the optical path of the present invention.

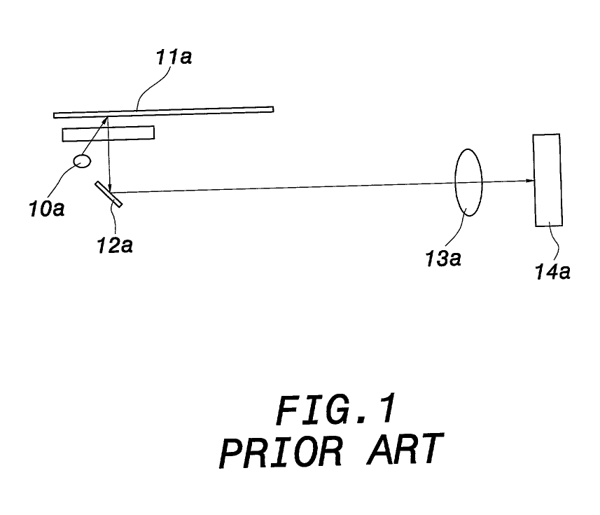

### DETAILED DESCRIPTION OF THE PREFERRED EMBODIMENTS

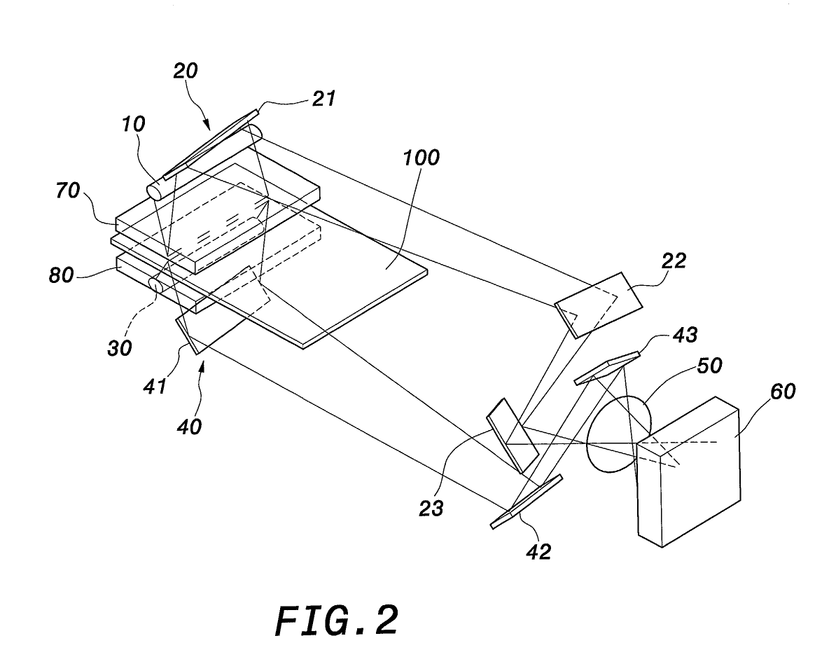

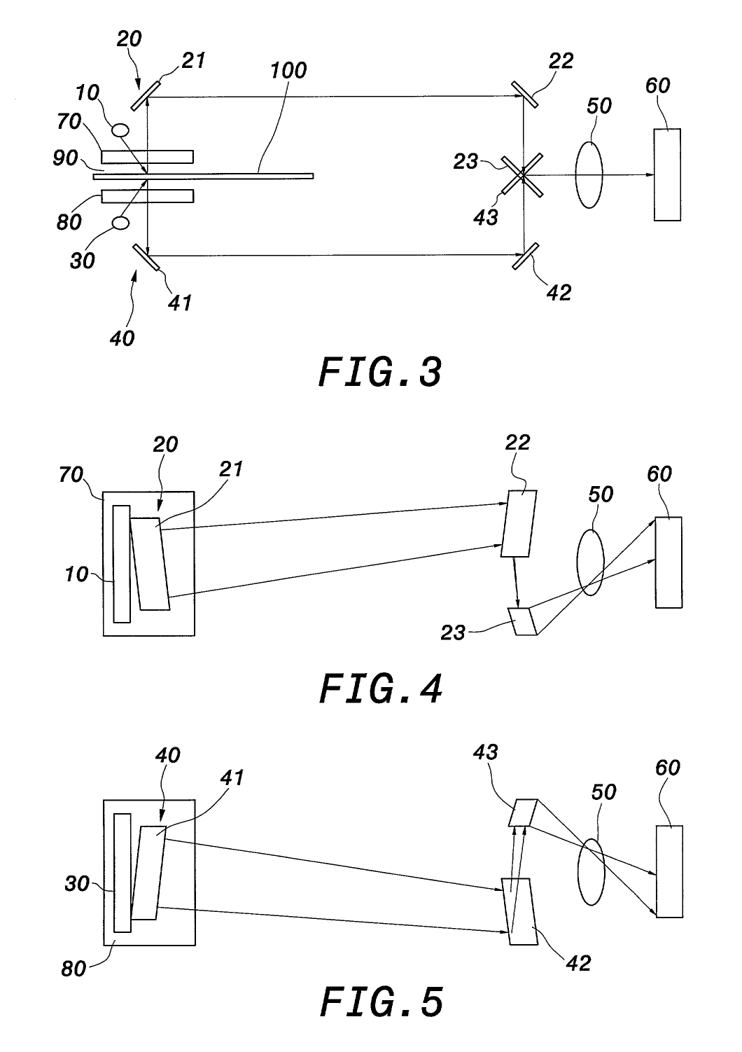

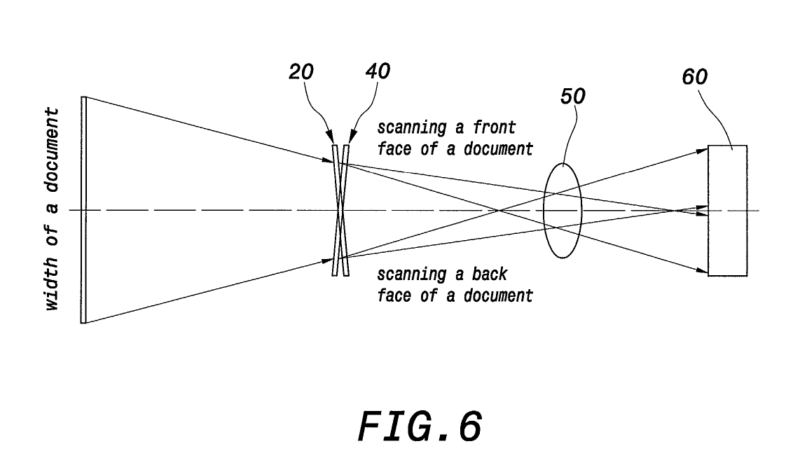

As shown in FIGS. 2 to 6, the present invention provides an optical path structure of a double-sided document scanner, which comprises a first light source 10, a first reflecting mirror set 20, a second light source 30, a second reflecting mirror set 40, a lens 50, and a photo-sensor 60. The optical path structure of the present invention is particularly suitable to card scanners. The first light source 10 and the second light source 30 are arranged up and down and properly fixed in a main body (not shown) of the scanner. A first glass 70 and a second glass 80 are disposed between the first light source 10 and the second light source 30. The first glass 70 and the second glass 80 are parallel arranged with a certain gap kept between them to form a document conveyance path 90. A document (manuscript) 100 can be driven by an appropriate conveying mechanism (not shown) to traverse the document conveyance path 90 between the two glasses 70 and 80. Lights generated by the first light source 10 and the second light source 30 are respectively projected onto a front face and a back face of the document 100.

The first reflecting mirror set 20 is properly fixed in the main body (not shown) of the scanner to reflect light reflected from the front face of the document 100 toward a proper direction. The first reflecting mirror set 20 comprises a first mirror 21, a second mirror 22, and a third mirror 23. The first mirror is disposed above the first glass 70 and slantingly arranged. The second mirror 22 is also slantingly arranged and disposed at the same height as the first mirror 21. The third mirror 23 is disposed below one side of the second mirror 22 and is also slantingly arranged. The third mirror 23 is disposed at the same height as the document conveyance path 90. The lengths of the first mirror 21, the second mirror 22, and the third mirror 23 progressively decrease in this order.

The second reflecting mirror set 40 is properly fixed in the main body (not shown) of the scanner to reflect light reflected from the back face of the document 100 toward a proper direction. The second reflecting mirror set 40 comprises a fourth mirror 41, a fifth mirror 42, and a sixth mirror 43. The fourth mirror is disposed below the second glass 80 and slantingly arranged. The fifth mirror 42 is also slantingly arranged and disposed at the same height as the fourth mirror 41. The sixth mirror 43 is disposed above one side of the fifth mirror 42 and is also slantingly arranged. The sixth mirror 43 is disposed at the same height as the document conveyance path 90. The lengths of the fourth mirror 41, the fifth mirror 42, and the sixth mirror 43 progressively decrease in this order.

The lens 50 and the photo-sensor 60 are properly fixed in the main body (not shown) of the scanner. The lens 50 and the photo-sensor 60 are disposed at the same height as the third mirror 23, the sixth mirror 43, and the document conveyance path 90. The lens 50 can focus the lights reflected by the first reflecting mirror set 20 and the second reflecting mirror set 40. The photo-sensor 60 is a CCD capable of transforming optical signals into acceptable analog or digital signals. Thereby, an optical path structure of a double-sided document scanner of the present invention is formed.

Lights generated by the first light source 10 and the second light source 30 can respectively pass the first glass 70 and the second glass 80 to be projected onto the front face and the back face of the document 100. The light reflected from the front face of the document 100 is reflected by the first mirror 21, the second mirror 22, and the third mirror 23 of the first reflecting mirror set 20 and then enters one side of the lens 50 to be focused onto one side of the photo-sensor 60 so that the photo-sensor 60 can transform these optical signals into acceptable analog or digital signals. At the same time, the light reflected from the back face of the document 100 is reflected by the fourth mirror 41, the fifth mirror 42, and the sixth mirror 43 of the second reflecting mirror set 40 and then enters the other side of the lens 50 to be focused onto the other side of the photo-sensor 60 so that the photo-sensor 60 can transform these optical signals into acceptable analog or digital signals. Thereby, a single pass of double-sided scanning is accomplished.

To sum up, the present invention can scan a double-sided document in a single pass, hence facilitating the operation of double-sided scanning for a user. Moreover, because only a single set of a lens and a photo-sensor needs to be provided in the present invention, a simple structure is obtained, thereby greatly reducing the cost and effectively enhancing the competitive capacity in market.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An optical path structure of a double-sided document scanner, comprising:
two light sources disposed up and down with a document conveyance path formed between them, lights generated by said two light sources being respectively projected onto a front face and a back face of a document;
a first reflecting mirror set comprising a plurality of mirrors and used to reflect light reflected from the front face of said document;
a second reflecting mirror set comprising a plurality of mirrors and used to reflect light reflected from the back face of said document;
a photo-sensor; and
a lens for focusing lights reflected by said first reflecting mirror set and said second reflecting mirror set onto said photo-sensor.

2. The optical path structure of a double-sided document scanner as claimed in claim 1, wherein said two light sources have a first glass and a second glass disposed between them, said first glass and said second glass being parallel arranged with a certain gap kept between them to be used as said document conveyance path.

3. The optical path structure of a double-sided document scanner as claimed in claim 1, wherein said first reflecting mirror set comprises a first mirror, a second mirror, and a third mirror, said first mirror being disposed above said first glass and slantingly arranged, said second mirror being also slantingly arranged and disposed at the same height as said first mirror, said third mirror being disposed below one side of said second mirror and slantingly arranged, said third mirror being disposed at the same height as said document conveyance path.

4. The optical path structure of a double-sided document scanner as claimed in claim 3, wherein lengths of said first mirror, said second mirror, and said third mirror progressively decrease in this order.

5. The optical path structure of a double-sided document scanner as claimed in claim 1, wherein said second reflecting mirror set comprises a fourth mirror, a fifth mirror, and a sixth mirror, said fourth mirror being disposed below said second glass and slantingly arranged, said fifth mirror being also slantingly arranged and disposed at the same height as said fourth mirror, said sixth mirror being disposed above one side of said fifth mirror and slantingly arranged, said sixth mirror being disposed at the same height as said document conveyance path.

6. The optical path structure of a double-sided document scanner as claimed in claim 5, wherein lengths of said fourth mirror, said fifth mirror, and said sixth mirror progressively decrease in this order.
